(19) United States
(12) Patent Application Publication
(10) Pub. No.: US 2007/0018906 A1
(43) Pub. Date: Jan. 25, 2007

(54) Product selection based on color and appearance of decorative artifacts

(76) Inventors: David William Visnovsky, Sparta, MI (US); David Alan Hoffer, Byron Center, MI (US); Ryan D. Anderson, Allendale, MI (US); Elizabeth Boll Ventura, Ada, MI (US); Timothy L. Walker, West Olive, MI (US); Mark A. Cargill, Belding, MI (US); Todd A. Sutton, Grand Rapids, MI (US)

Correspondence Address: KIRKPATRICK & LOCKHART NICHOLSON GRAHAM LLP, 535 SMITHFIELD STREET, PITTSBURGH, PA, 15222, US

(21) Appl. No.: 11/487,553

(22) Filed: Jul. 14, 2006

Related U.S. Application Data
(60) Provisional application No. 60/699,487, filed on Jul. 15, 2005.
(60) Provisional application No. 60/699,606, filed on Jul. 15, 2005.

(51) Int. Cl. G09G 5/00

(52) U.S. Cl. 345/1.1

(57) ABSTRACT

Systems, methods, processes, and devices are disclosed for measuring and matching the color and appearance of decorative artifacts to facilitate product selection, such as in a retail store or other commercial environment.

### CROSS REFERENCE TO RELATED APPLICATIONS/PRIORITY CLAIMS

This application claims the benefit of priority of U.S. Provisional Patent Application No. 60/699,487, filed on Jul. 15, 2006, and U.S. Provisional Patent Application No. 60/699,606, filed on Jul. 15, 2006.

### FIELD OF THE INVENTION

The invention generally relates to measuring and matching color and appearance of artifacts to assist in product selection. The invention more particularly relates to systems, processes, and devices for measuring and matching the color and appearance of decorative artifacts to facilitate decorative product selection.

### BACKGROUND

The selection and coordination of colors to decorate an environment such as the interior of a residence is often a difficult and daunting task. The process typically begins with one or more products or other artifacts around which a color theme is established by a customer. The artifact may be a fabric (e.g., a curtain or a pillow), a floor covering (e.g., carpet or tile), a wall covering (e.g., wallpaper), a paint swatch, an accessory (e.g., a vase), or many other articles or types of decorative artifacts. The customer typically needs to travel to multiple retail stores in a quest to identify fabrics, upholstery materials, and/or other products that match or coordinate with the decorative artifact.

There are numerous problems with this product selection process. The customer must rely on a salesperson's knowledge of available products. Given the reality that any particular retailer often has many products available, such knowledge is usually less than comprehensive. Also, the customer must usually rely on the salesperson's perception of which products contain particular colors or appearances that would be considered desirable by the customer. In some cases, customers may be permitted to personally search for products (e.g., by paging through design books), but such searches can be frustratingly inefficient and time-consuming.

Another problem that arises from product selection in association with the design process is how to effectively illuminate, scan and otherwise evaluate decorative artifacts. Many conventional imaging systems require objects to be positioned within an enclosure. Such systems can be cumbersome, however, and usually require operation by a skilled and experienced operator. Also, opening the enclosure for insertion and removal of the object provides an opportunity for dirt and other contaminants to enter the enclosure and contaminate the equipment. This can negatively impact the quality of images generated by the system.

Another such imaging system is the conventional color copier, which includes an enclosure having an upper window on which the objected to be copied is positioned. Within the enclosure of the copier are illumination sources and imaging equipment that illuminate and image the object. However, the object to be copied must be capable of conforming to the planar window of the copier. Another shortcoming of color copiers is the opportunity for ambient light to enter the window around the edges of the object being imaged. Ambient light detracts from the quality of the color of images generated by such devices.

In view of the foregoing issues, what are needed are more effective and efficient ways to assist consumers in selecting products in conjunction with the color and appearance of decorative artifacts.

### BRIEF DESCRIPTION OF THE FIGURES

The utility of the embodiments of the invention will be readily appreciated and understood from consideration of the following description of the embodiments of the invention when viewed in connection with the accompanying drawings.

FIG. 1 includes a schematic illustration of various process flows provided in accordance with certain embodiments of the invention;

FIG. 2 includes a schematic illustration of various process flows provided in accordance with certain embodiments of the invention;

FIG. 3 includes a schematic illustration of various process flows provided in accordance with certain embodiments of the invention;

FIG. 4 includes an illustration of various system architecture elements provided in accordance with certain embodiments of the invention;

FIG. 5 is a schematic that illustrates a system for accessing devices through a web browser provided in association with certain embodiments of the invention;

FIG. 6 includes a flow chart that illustrates an example of a method for quantizing the colors in an artifact, material, product, or other object, which may be employed in association with certain embodiments of the invention;

FIG. 7 includes a flow chart that illustrates an example of a process for identifying color-correlating materials in accordance with certain embodiments of the invention;

FIG. 8 is a perspective view of a retail kiosk housing or containing a color measurement system or imaging system that can be structured in accordance with certain embodiments of the invention;

FIG. 9 is a horizontal sectional view through FIG. 8;

FIG. 10 is a sectional view of a portion of FIG. 8;

FIG. 11 is a sectional view of a portion of FIG. 8;

FIG. 12 is a perspective view of an example of a color measurement system or imaging system that can be provided in accordance with certain embodiments of the invention, with the kiosk removed and showing the cover in the raised position;

FIG. 13 is a top perspective view of the window cover of the system of FIG. 12;

FIG. 14 is a bottom plan view of the window cover of FIG. 13; and,

FIG. 15 is a bottom perspective view of the window cover of FIG. 13, including a color checker.

### DESCRIPTION

Embodiments of the invention simplify and streamline the usually consumer-driven process of finding and selecting color-coordinated decorative products, such as home decorating articles, for example. It can also help sales associates offer and sell products more efficiently, by enabling them to guide consumers through various design and color choices. The invention facilitates capturing an image of a decorative artifact (e.g., pillow, fabric, paint swatch, wallpaper sample), and then searching a database of decorative products (e.g., furniture, wallpaper, paint) for products that match or correlate with the decorative artifact and/or an overall design scheme.

In various embodiments described in more detail hereinafter, a product selection system employs an image capture device to illuminate the decorative artifact and take an image of it. Software executed on a computer system (e.g., connected via LAN or WLAN) controls the image capture device (e.g., via a web services server) and retrieves the image from it. The image capture device may be portable or fixed; and/or spot-based, image-based, or BRDF-based. The software may be installed on a local computer system and may also invoke software on a web server farm, for example, to search a database of decorative products containing images and color data about the products. The product database may also contain information about the physical location of products in a retail store or stores, for example. Such location data may include information about stores or other commercial establishments of diverse geography that may have a desired product available for purchase by the consumer. The product database may be operatively associated with a consumer registry database, which can contain color preferences for each consumer. The product selection system may also utilize a rendering system to display a fabric on a furniture frame, for example, or various decor items in a room scene.

In operation, the local (e.g., browser-based) software handles user or consumer interactions with the product selection system. It may control a camera (e.g., through web services) of the image capture device, and/or may request that the server farm find or render fabrics, among other types of decorative products. Color management can be applied upon database capture, in-store capture, and/or in association with a monitor display of the product selection system to optimize color accuracy. In certain embodiments, one or more algorithms may be used to identify important colors or other appearances of a consumer's sample or decorative artifact.

In various embodiments, color can be controlled in several aspects of the product selection system, thereby providing accurate color assessment for sales associates and consumers. The system can capture an image (i.e., not just a spot reading) of the consumer's sample or decorative artifact, thereby letting the consumer work with multi-colored samples. The system can help guide consumers to choices of colors and can help the sales associate find color combinations, thereby speeding up the sales cycle. It can be seen that embodiments of the invention can be used in any retail situation where color is important (e.g., home or interior decorating, apparel, cosmetics, etc.). In certain embodiments, the product selection system may be connected for communication and/or processing in operative association with various supply chain systems to drive color quality from the factory, for example, to the consumer.

Embodiments of the invention may include a product database of color and appearance information related to available materials or decorative products. The product database can be configured to identify each product or material and its constituent color and appearance information. As applied herein with respect to a product attribute or characteristic such as color, for example, the term “constituent” refers to the material colors that are visually important or visually dominant. Appearance information for a decorative artifact may also include non-color items that affect the visual appearance of the artifact such as gloss and surface texture, for example. The material can be any single-color or multi-color material, for example, as would be found in stripes, plaids, and patterns. In various embodiments, imaging the consumer decorative artifact and identifying the constituent colors and appearance characteristics within the artifact can be performed. Based on the constituent color and appearance elements in the artifact and the materials, the product selection system can be configured to identify those materials or decorative products that match, coordinate, harmonize, or otherwise color correlate with the artifact.

In various embodiments, the product database may also include information related to the physical properties and location of each product, and/or other attributes. Accordingly, the product selection system can identify to the customer and/or salesperson the particular location within a retail environment or environments of color-correlating products. For example, if products are being selected for a bathroom, the system can identify the location within a store or multiple stores of floor coverings, window curtains, shower curtains, laminates, and tiles that correlate with the customer artifact. This identification of location can enhance the shopping experience for the customer and accelerate the product selection process. Physical properties such as gloss level of paints or texture of fabrics, for example, can also be used to help in correlating the products. These appearance-related properties can affect consumer perception of the artifact and its color. In certain embodiments, a consumer registry database may be employed by the product selection system. Each customer's color preferences and/or material or product preferences can be stored in the customer registry database for future reference to facilitate subsequent material or decorative product selections.

The colors in a customer decorative artifact or decorative product may be quantized in various embodiments by: (1) using a known algorithm to reduce the total number of colors to a fixed number; and, (2) collapsing the quantized colors into a set which represents the actual colors in the artifact. One example of this is a recursive Delta E approach as understood by those skilled in the art. This aspect of the invention can enhance the identification of the constituent colors within an artifact.

In certain embodiments of the invention, a methodology for communicating with hardware (e.g., an image capture device) from within a web browser or other computer based application is provided. This communication may occur between hardware located locally or remotely, and may be done via direct connection or wirelessly. The communication may be enabled by one or more handheld wireless devices that communicate via a GPRS/GSM network, for example, either locally or remotely. This communication methodology enables image information to be captured and communicated throughout a business environment or a supply chain, for example, through various web-based, server-based, and/or desktop-based applications.

The invention may also, in certain embodiments, enhance color rendition of decorative artifacts and their coordinating products to manipulate and render images more correctly for display purposes (e.g., on a monitor display of the product selection system).

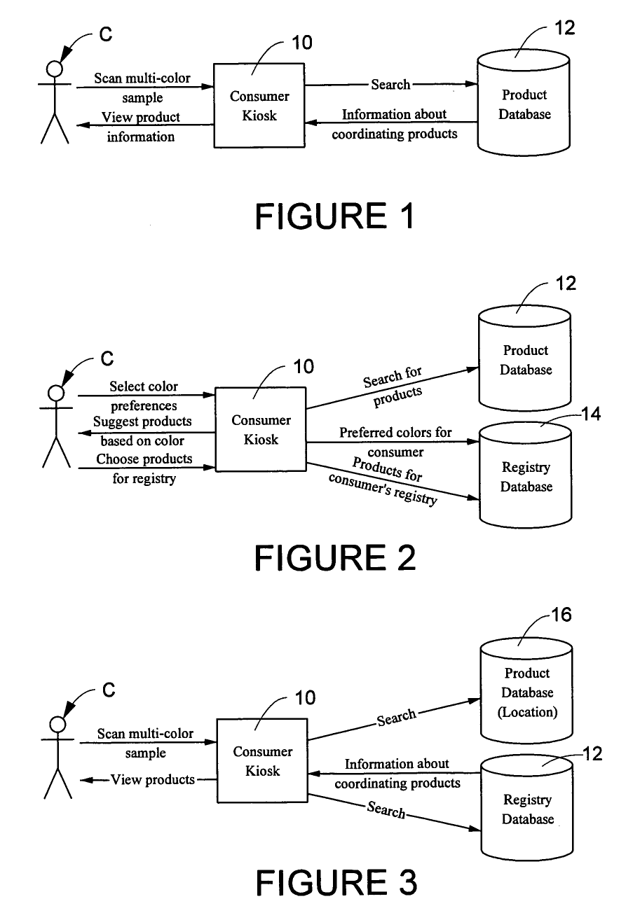

With reference to FIG. 1, an example of potential customer C interaction with an example of the product selection system of the invention is illustrated. The primary interface with the product selection system for the customer C may be a consumer kiosk 10, for example (specific potential embodiments of the kiosk 10 are disclosed herein below in more detail). In operation, the customer C can bring a multi-color sample or decorative artifact to the consumer kiosk 10 either directly or with the assistance of a salesperson. The sample can be imaged and the color content or appearance of the sample quantized in accordance with one or more algorithms described herein. Based on the quantized colors, the system may search a product database 12 containing color information, among other data, for the available materials or decorative products. Information regarding any correlating products uncovered in the search can be returned to the customer C by way of a monitor, for example, or other screen display within the kiosk 10.

The database 12 may be on the same computer as the computer in the kiosk 10, or the database 12 may reside on a separate computer or on a separate remote computer. The database 12 could be either one large database or a combination of several databases. The decorative products could be virtually any retail product including, for example and without limitation, furniture, clothing, flooring, wall coverings, window treatments, bedding, towels, doors, windows, paint, and home décor. After the system quantizes the colors within the artifact, swatches of the colors within the artifact can be displayed to the customer C on the monitor, for example. The customer C has the option of identifying the specific color or colors to be used in the product search. Although particular color spaces are described herein, the product selection system may use any suitable color space. The system may be voice-responsive so that the customer C can verbally command the system (e.g., by issuing a command such as “find red items”). The consumer kiosk 10 may be in a retail store, in the customer's C home (if suitably sized), or in virtually any location. The product information stored in the database 12 may include images, colors, or any other characteristic associated with the material or decorative products, such a physical or geographical location of a store or stores that offer the products for purchase.

FIG. 2 illustrates another example of consumer interaction in association with product selection system embodiments of the invention. In addition to the database 12, the product selection system includes a customer registry database 14. The customer registry database 14 can include information regarding each consumer, each consumer sample or artifact, each consumer's preferred colors, and/or each consumer's product selections. Consequently, the system is capable of subsequently identifying to the customer C and to other consumers the products identified by the customer C as being of specific individual interest. As shown, the registry database 14 may be operatively separate from the product database 12, or the two databases 12, 14 may be combined in some reasonably operative manner. The original customer C or other consumers may look up information in the registry database 14 from a retail store, from a home or residence, or from any other location having communication access to the database 14.

As shown more particularly in FIG. 3, a product location database 16 may be provided which includes information regarding the physical location of the products within the product database 12. This enables information regarding the location of each product to be displayed to the customer C in conjunction with each specific decorative product. The product location may be within the same store, a related store, and/or an unrelated store. In certain embodiments, the databases 12, 16 can be configured to operate separately or can be combined into a single database.

As shown in FIGS. 1 through 3, the product databases 12, 16 may contain information regarding available products, color information, and/or color content of the products. Also, the consumer kiosk 10 or other customer interface can be provided to enable a consumer artifact to be scanned, and to facilitate display of product information to the customer C in response to color content of a sample. Consequently, embodiments of the invention facilitate a rapid identification and display to the customer C of candidate products color correlating to colors contained within the sample.

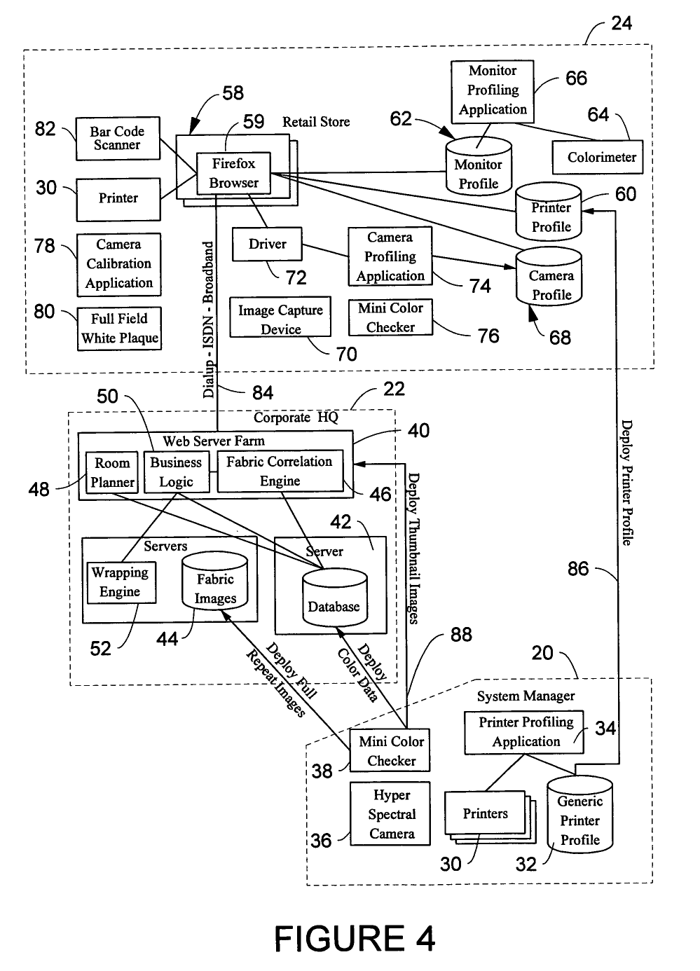

FIG. 4 illustrates an example of a high-level system architecture provided in accordance with certain embodiments of the invention. As shown, hardware can reside at three different locations: the system manager 20, the retail corporate headquarters 22, and the retail store 24. Information can be communicated and exchanged between/among the three locations as described herein.

The system manager location 20 includes printers 30, generic printer profiles 32, and a printer profiling application 34. Also, located at the system manager location 20 are a hyper-spectral camera 36 and color lab software 38 connected to the camera. The system manager 20 provides profiling of the printers. The hyper-spectral camera 36 may be used to image the materials to be stored in the corporate headquarters 22 database 42. Although the present embodiment is described in conjunction with upholstery materials, it will be readily appreciated by those skilled in the art that the technology can be extended readily to any application in which color correlation is beneficial such as clothing, floor coverings, wall coverings, or any other decorative artifact or decorative product.

A web server farm 40 can be located at corporate headquarters 22 to interface with one or more retail stores 24. The upholstery material database 42 can be located at the corporate headquarters as well as a database of fabric images 44. A fabric correlation engine 46 may be resident within the web server farm 40 and operative to correlate customer artifacts with materials stored within the database 42 as will be described. Other software that can be included on the web server farm includes a room planner 48 and/or business logic 50. Additionally, a wrapping engine 52 can be resident at the corporate headquarters location enabling a fabric image, for example, to be visually “wrapped” onto a desired article, such as a chair or sofa, for example. The modules 48, 50, and 52 are known to those skilled in the art.

A variety of hardware and software can be resident within the retail store 24. The hardware and software may be contained within the consumer kiosk 10, as described above. The retail store 24 includes a printer 30 and a printer profile 60. The profile 60 is deployed to the retail store 24 from the system manager 20. A monitor profile 62 is included at the retail store 24 for use in conjunction with a monitor (not shown), or other screen display. The monitor profile 62 can be created using a conventional colorimeter 64 in conjunction with a conventional monitor profiling application 66, both of which are known to those skilled in the art. A camera profile 68 may also be resident on the computer 58 within the retail store 24. The camera profile 68 is associated with the image capture device 70, which can be an RGB camera, for example. Alternatively, the image capture device 70 could be a multi-spectral or hyper-spectral camera, in which case the camera profile 68 may not be required. A driver 72 is associated with the image capture device 70, and the profile 68 is created using a conventional camera profiling application 74. All of the software components may reside on the computer 58 located within the kiosk 10 in the store 24. The computer 58 may also include a web browser 59, which can be a “Firefox” trade-designated browser.

In certain embodiments, a physical mini color checker 76 can be provided to work in conjunction with a camera calibration application 78 to calibrate the image capture device 70. A full field white plaque 80 may be provided for use in conjunction with calibration and profiling of the image capture device 70. Also, a barcode scanner 82 may be connected to the computer 58 so that conventional barcode indicia, such as those placed on individual material or decorative product samples, can be easily entered into the computer 58.

A connection 84 can be provided between each retail store 24 and the corporate headquarters 22. The connection may be dial-up, ISDN, broadband, or any other wired or wireless connection known to those skilled in the art. A variety of information can be deployed or communicated from the system manager 20 to the corporate headquarters 22 and to the retail store 24. Printer profiles can be deployed at 86 from the system manager 20 to the retail store 24. Thumbnail images of upholstery materials, for example, or other decorative products can be deployed 88 to the web server farm 40. Color data associated with each material or decorative product can be deployed to the database 42. Also, full repeat images of each material or decorative product can be deployed to the fabric image database 44.

It will be appreciated by those skilled in the art that FIG. 4 illustrates a current embodiment of the various hardware and software components. It also will be appreciated that the hardware and/or software can be distributed in a variety of ways. For example, the product database and the fabric correlation engine 46 could be resident on a computer 58 at each of the retail stores 24. It can be seen that the current embodiment provides balance among controllability, simplicity, efficiency, and cost.

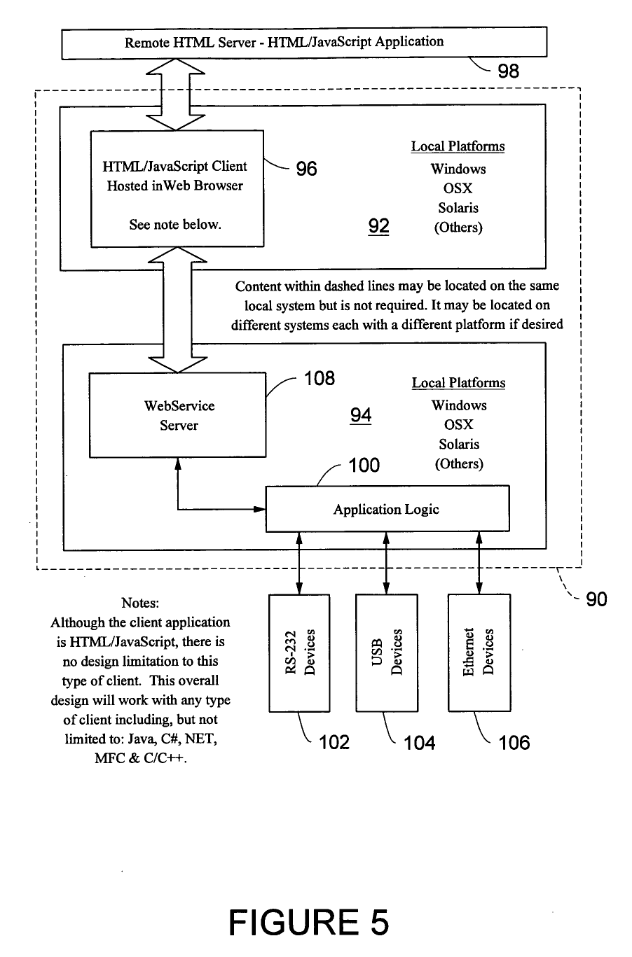

FIG. 5 illustrates the methodology of communicating with local hardware (e.g., an image capture device or imaging device) from within a web browser. The components within the dashed line 90 may be located on the same local system, but also may be located on different systems each with a different platform. Each of the local platforms 92 and 94 may be Windows-based, OSX-based, Solaris-based, or based on any other platform. The platform 92 includes an HTML/JavaScript client hosted-in web browser 96, which can communicate with any remote HTML server or HTML/JavaScript application 98. The platform 94 includes application logic 100 for the hardware devices connected to the local platforms. In various embodiments, the connected devices may be one or more RS-232 devices 102, USB devices 104, Ethernet devices 106, or any other wired or wireless device known to those skilled in the art. Also included within the platform 94 is a web service server 108. The web service server 108 communicates with both the application logic 100 and the web browser 96. Although the embodiment shown is disclosed as HTML/JavaScript, there is no design limitation to this format. The design will work with many types of clients including, but not limited to, Java, C#, NET, MFC, and C/C++.

Traditionally, creating and operating a desktop computer program that used local computer devices or hardware was common. C++ applications, for example, installed and running on Windows can communicate with serial (RS-232), USB & Ethernet devices. A web application is an HTML application hosted in a browser, and Internet Explorer (IE), Netscape, Firefox & Safari are examples of commonly used browsers. Standards-based browsers do not typically allow the application to use local device resources. In general, the only resources they can directly use have to be located on the same domain (URL) from which the web page was loaded. Even Java applets reside in the “sandbox” of the browser and cannot access local device resources. These restrictions are usually imposed for security reasons.

ActiveX controls can be downloaded from various websites and installed on local computers using IE. Websites that use this approach may effectively make Windows and IE the only platform that can access the websites. The reason for this is that ActiveX controls are COM components which are binary Windows executables (applications). Therefore, it has not been possible to write standards-based browser applications that use local hardware resources such as serial ports and USB devices.

There has been a need for different computer systems to communicate with each other across wide area networks (WANs). DCOM, CORBA & various IIOP techniques have been used but have been generally ineffective for the primary reason that they require certain IP ports to be open in corporate networks and/or require the use of Windows. Information technology managers have been forced as a practical matter to shut off all such ports in corporate firewalls because of security concerns. The ports that remain open are the well known ones; such as port 80 for the web.

There has been a migration from these prior techniques to Web Services. Web Services solves the security/firewall problem by using port 80. It is also a standard that does not require the use of Windows systems. A Web Service server can be accessed by any client on any platform in any location in the world. In addition, the server can be on any platform as well. Web Services use Internet standards including IP/HTTP/XML. The HTTP/XML layer is known as SOAP (Simple Object Access Protocol). Web Services represent a way for computers to communicate using the same web that users browse with browsers.

In various embodiments, a local web page can be called the local web service using JavaScript. Two options exist for doing this. The first option is based on the current Mozilla-based browsers such as Firefox and Camino. Mozilla provides a client web service API that allows one to call the web service using JavaScript. In other browsers that do not have direct web service client APIs, one can use the xmlHttpRequest object which is a lower level way of accessing the local web service. Since the web page is being served from a corporate server, the present local web service is not on the same domain as the source for the web pages. Since web services are typically more securable than ActiveX controls (because web services use standard web techniques that are securable rather than uncontrolled binary executables), it is possible to implement security systems that allow for more than the same source restriction. Mozilla, for instance, has released a new web services security model (Securing Resources from Untrusted Scripts Behind Firewalls). This and other techniques allow the current system, which is a browser-based user interface, to communicate with local hardware or other components, such as a camera or another image capture device.

Using web services provides the added benefit that it is independent of the operating system of both the local server and the programming language of the client. If the programming language of the user interface portion of the application is changed to C++, Java, NET or another language, that change will not negatively affect the web service, because the current system generates web service client code that can be used to call the web service. In addition, because the current system uses C++ and Java to implement the web service server, the system can run the local code on any platform supported by Java and C++.

Digital images can contain anywhere from a few hundred unique colors to thousands of unique colors or other appearance effects. For example, a solid blue fabric image may contain over 500 different blue pixels in order to best represent the fabric. On the other hand, when a human eye looks at the same blue fabric, it may only see a few different shades of blue that make up that same fabric. The human eye is not interested in the over 500 unique blue pixels that represent that fabric, but is interested in the few dominant blue colors that can be perceived. Accordingly, embodiments of the invention may employ color quantization.

Color quantization is the process of reducing the number of colors in a digital image with minimal visual distortion. This concept is useful because one of the goals of the invention is to search a database of fabrics, for example, and return the closest matching fabrics or other decorative products based on a user selected source color. In order to allow the user to select a source color, a quantization algorithm can be used to reduce the thousands of unique colors down to a smaller number of colors that best represent the image data. Embodiments of the invention may use a known algorithm that quantizes based on color data variance. The algorithm is described in a document entitled, “Color image quantization using distances between adjacent colors along the color axis with highest color variance” (authored by Y. Sirisathitkul, S. Auwatanamongkol and B. Uyyanonvara and published in Pattern Recognition Letters, Vol. 25, Issue 9, Pages 1025-1043, 2 Jul. 2004). This algorithm divides the color space of a digital image into 128 regions, where the center coordinate or color point represents that region. Any pixel color that falls in a specific region is then defined by the center color point. While 128 regions may be used with this algorithm, it will be readily appreciated that other numbers of regions could be used. Also, the number of regions could be dynamic based on the content of the image or other factors.

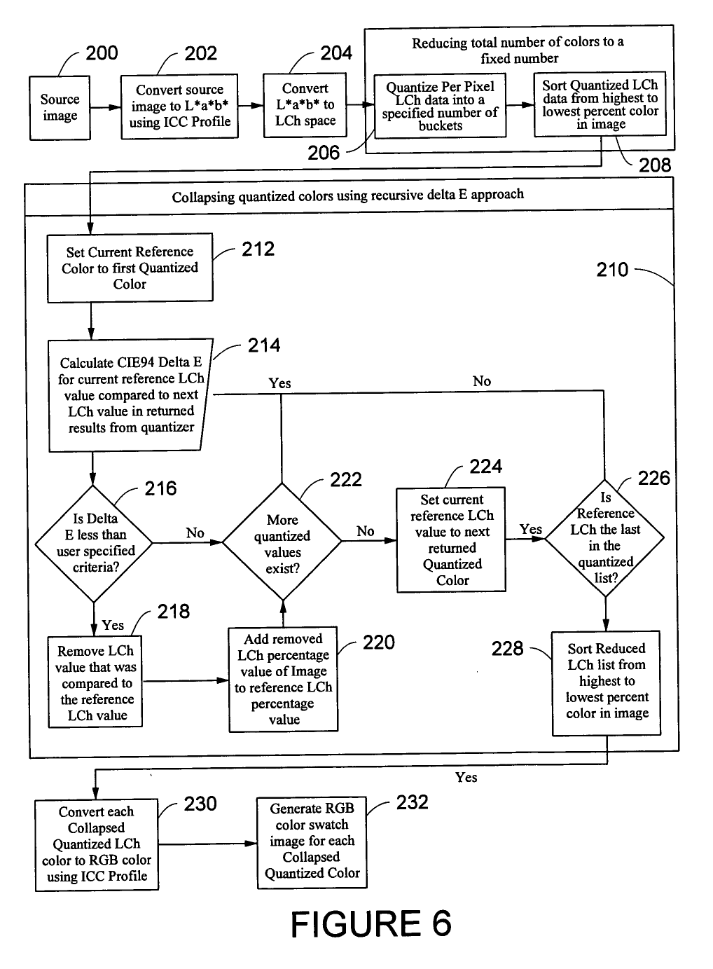

FIG. 6 illustrates an example of a process flow for quantizing and collapsing the constituent colors with a source image, whether the image is of an available upholstery material, for example, or another decorative artifact. The source image 200 is acquired using imaging system hardware and image capture devices described herein. At 202, the product selection system converts the source image from RGB data to Lab data using an ICC profile as is known to those skilled in the art. The Lab data is then converted at 204 to LCh data. Steps 206 and 208 quantize the total number of colors in the image to a fixed number, such as 128, for example. In certain embodiments, the number of buckets can be dynamically determined, based on the content of the image. First, the per pixel LCh data is quantized 206 into the pre-selected number of buckets. Second, the quantized LCh data is sorted 208 from highest to lowest percent color in the image.

The quantized data can then be returned in reverse-sorted order so that the first color returned is the highest percentage color in the entire image. The second color then represents the second highest percentage color in the image, and the last color represents the lowest percentage color in the image. The collapsing algorithm (i.e., the processing inside of the line 210 in FIG. 6) starts with the first color returned, and looks at all the other colors comparing the color space distance. If any of the other colors in the quantized color list is within a specified distance in color space, then it is removed from the quantized list of colors. The second color is then chosen and compared to the remainder of colors in the list, and appropriate colors are removed. This continues until the end of the quantized color list is reached. The end result of this collapsing technique is a human perceivable list of distinct colors that represent the digital image.

The processing that occurs within the line 210 can collapse the 128 quantized colors using a recursive Delta E approach. The first quantized color is set 212 as the Current Reference Color. At 214, the system then calculates the CIE914 Delta E for the Current Reference Color LCh value compared to the next LCh value in the sorted quantized colors. At 216, if the Delta E is less than a user specified criteria (currently 6 Delta E), then the next LCh value that was compared to the Current Reference Color LCh value is removed at 218. The LCh percentage value of the next LCh value is added at 220 to the Current Reference Color LCh value.

Returning to block 216, if the Delta E is not less than the user specified criteria, the system checks at 222 to determine whether additional quantized values exist. If one or more such values exist, process flow returns to block 214. If no more quantized values exist, the current reference LCh value is set at 224 to the next sorted quantized color. If the current reference LCh value is the last in the quantized list, flow passes to block 228. If the current reference LCh value is not the last in the quantized list, process flow returns to block 214. At block 228, the reduced LCh list is sorted 228 from highest to lowest percent color in the image.

In order to display the distinct colors to the user on a monitor (e.g., an “Apple iMac” monitor), digital images of each color can be created. The quantization and collapsing algorithms return results in the CIELAB space. To show the color on the screen, a digital image must be created. This is done by creating a blank digital image set to a specific size. Next, all pixels in that digital image are set to a single CIELAB color value. This enables a digital image to be created representing one of the colors. This process can be repeated for each collapsed quantized color. After the color images are generated, they can be converted at 230 to RGB color space to be displayed correctly on a monitor. Using the Lab pass-through ICC profile as an input, and the monitor's ICC profile as an output, a digital image can be created at 232, which can be displayed on the monitor or another screen display for users to view.

Before the system searches the product database, the user is shown images representing the various colors in the imaged artifact. The user can then select a specific color to start the search process. Options for various categorized fabrics such as solids, patterns, and stripes also may be specified before the search. After the user selects the colors/options and starts the search, the CIELAB value associated with the image representing that color is sent to the fabric search engine 46 (see FIG. 4). The search engine then looks at the 128 quantized colors from each fabric or other decorative products in the database, and compares the distance (specifically CIE DE94) in color space between the database color and the user selected color. Fabric images are returned based on the color distance closeness, and displayed to the user on the monitor. Because the quantization process can be time consuming, the 128 color quantized data per fabric is pre-generated and stored in the database, so only color data point comparison is done at search time. In addition to returning fabrics with the closest color match, other algorithms may be used to search for fabrics that contain complementary colors, harmonizing colors, and/or other colors.

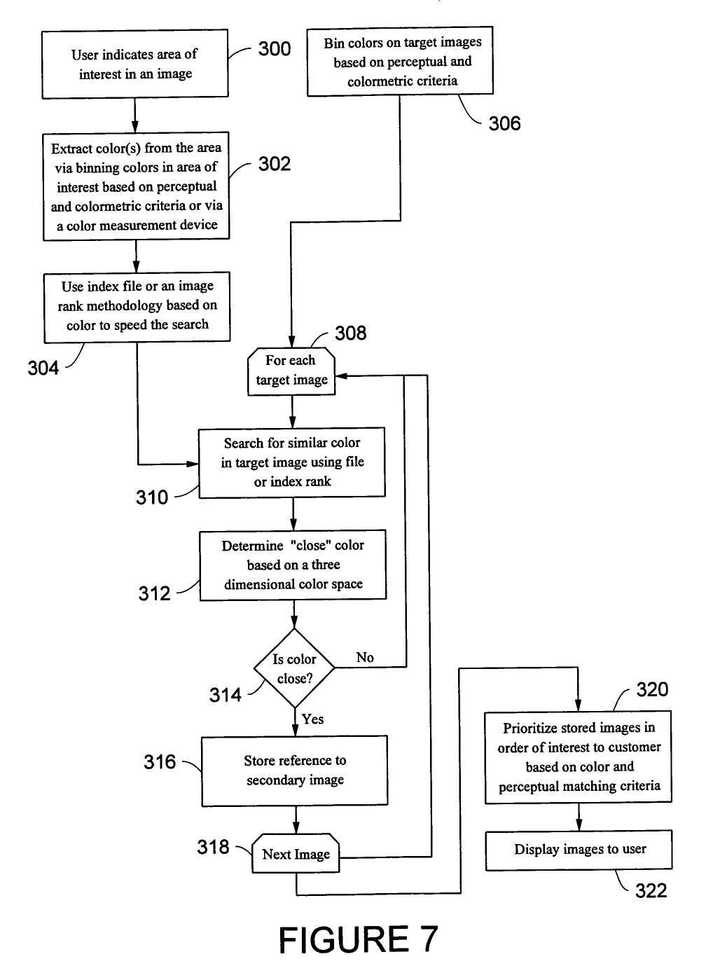

FIG. 7 illustrates a flow chart of the methodology for matching color information within the database with the color information from the customer decorative artifact. Blocks 300, 302, and 304 are a condensation of the methodology illustrated in FIG. 6 for quantizing and collapsing the colors of interest from the customer artifact. All of the materials within the retail collection can be processed using the methodology illustrated in FIG. 6 to bin the colors in those images at 306. For each target image at 308, a search at 310 is conducted for similar colors in the target image using a file or index rank. The closeness of each color is determined at 312 in a three-dimensional color space using known techniques. At 314, if the color is close according to pre-selected criteria, the material reference is stored at 316, the next material image is selected at 318, and process flow returns to block 308. At 314, if a color is not close, process flow returns immediately to block 308. After the colors in the material images have been compared to the colors in the customer artifact, the stored material images can be prioritized at 320 in order of interest to the customer based on color and perceptual criteria. The images of the materials can then be displayed at 322 to the customer on the monitor in the kiosk 10, for example.

It can be seen that embodiments of the invention greatly facilitate and speed the process of identifying candidate decorative products that correlate by color or appearance to a customer decorative artifact or other material. The process eases the shopping experience for the consumer, and can also improve the success rate and the closure speed of sales for the salesperson. Thus, greater sales volume through the store can be achieved. Additionally, the consumer and the salesperson have a higher confidence level that the best possible candidate products have been identified.

Imaging systems and image capture devices that may be employed in association with embodiments of the invention can be provided. In various embodiments, the imaging system can include an enclosure having a sample window on which a decorative artifact sample may be positioned. Within the enclosure are one or more illumination sources and a camera or other imaging device. A movable cover is mounted on the enclosure for selectively covering the window. When the cover is raised, the window is readily accessible for placement or removal of a sample. When the cover is closed, the cover completely overlies the window to prevent ambient light from entering the window. The cover may include an integral mini color checker that can be selectively positioned on the window. When the color checker is exposed and the cover is closed, the imaging system can read the color checker during calibration. When the color checker is not exposed, the cover can be used to exclude ambient light during image capture.

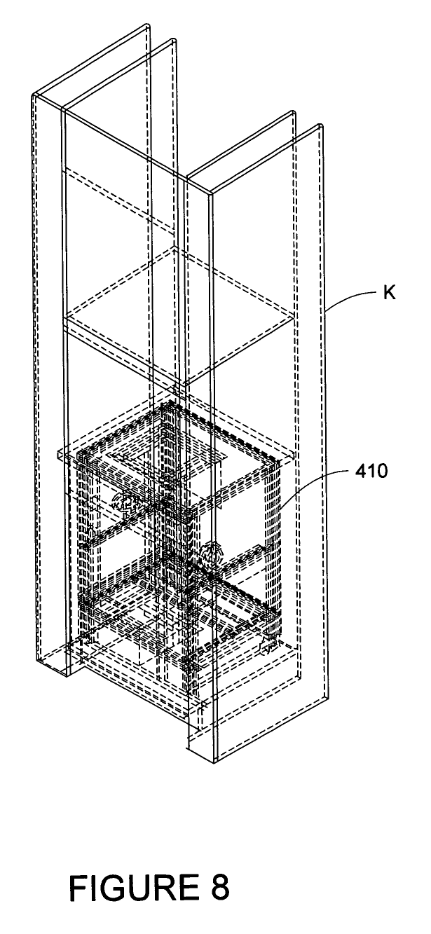

A color measurement system constructed in accordance with certain embodiments of the invention is illustrated in the drawings and generally designated 410, as shown in FIG. 8. The color measurement system 410 can be contained or housed within a cabinet or kiosk K. A computer and monitor (not shown) can also be contained within the kiosk. In the embodiment shown, the kiosk K is designed for location within a retail store or other similar environment.

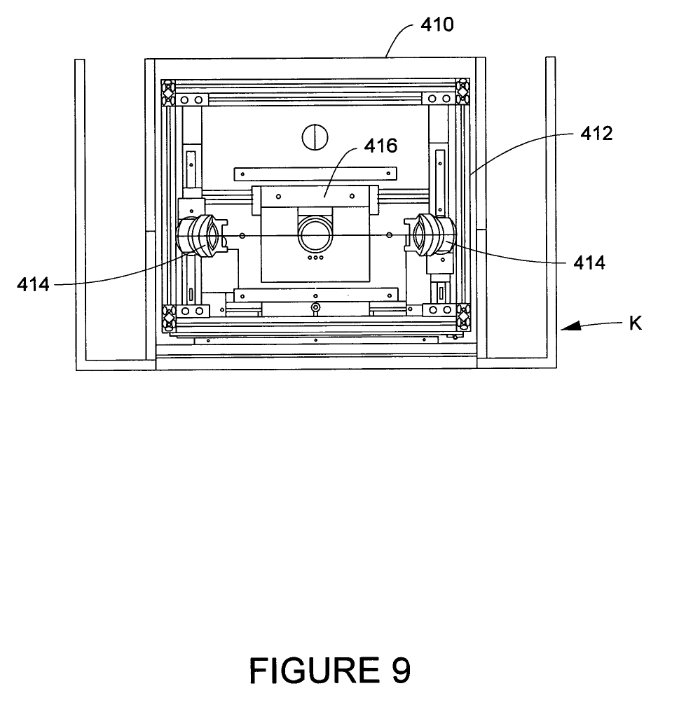

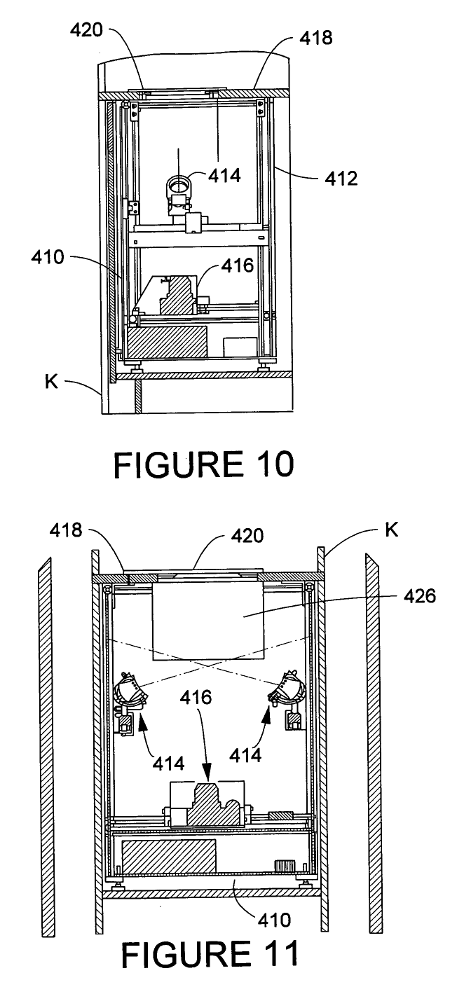

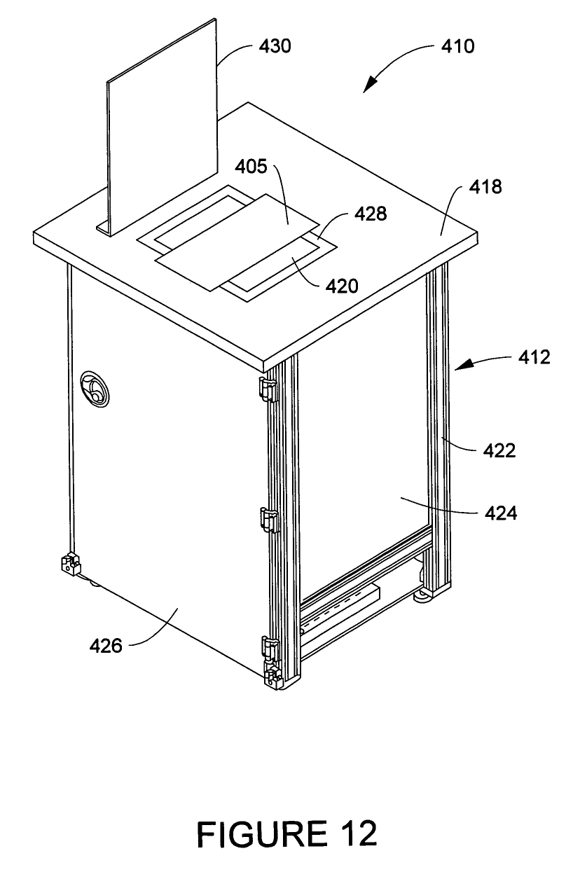

As illustrated in FIGS. 9 through 11, the color measurement system 410 includes an enclosure 412, illumination sources 414, and a camera or other imaging device 416. The enclosure 412 (see FIG. 12) includes frame members 422, a plurality of panels 424 supported by the frame, and a countertop 418 supported by the frame. At the front of the enclosure 412 is a door 426 providing access to the interior 412 of the enclosure 412 for servicing. Surfaces and components within the enclosure can be painted flat black to avoid glossy or non-uniform reflection. A transparent sample window 420 is mounted in the countertop 418. The illumination sources 414 are supported within the enclosure 412 using any suitable means. Although two illumination sources 414 are shown, any number (including one) of sources 414 could be used. The illumination sources 414 can be D50 light sources, for example. The illumination sources 414 can be directed upwardly and laterally to provide diffuse light to the entire window 420.

A pair of white vinyl panels 426 is provided on opposite sides of the window 420. The panels 426 assist in directing light from the illuminators 414 to the window 420. Other devices may be included for controlling and/or directing the light within the enclosure 412. The camera 416 can be mounted in the lower portion of the enclosure 412 using any suitable means. The camera 416 is aimed at and focused on the window 420 so as to be capable of imaging the entire window 420 area. The camera 416 can be, for example, the trade-designated “Rebel XT” by Canon. Other suitable cameras that can be used are known to those skilled in the art.

The window 420 is coplanar or flush with the horizontal surface 418. The window 420 includes a frame 428 surrounding the window 420. A cover 430 is secured to the upper surface of the countertop 418. The cover 430 may be moved between a raised or opened position (as illustrated in FIG. 12), and a lowered or closed position (not specifically shown) in which the cover 430 is located over the window 420. When the cover 430 is raised, a sample 405 may be positioned on the window 420. The cover 430 is sufficiently large so that it covers the entire window 420 when in the lowered position. Preferably, the cover 430 extends laterally beyond the window 420 in all directions to improve its function of excluding ambient light.

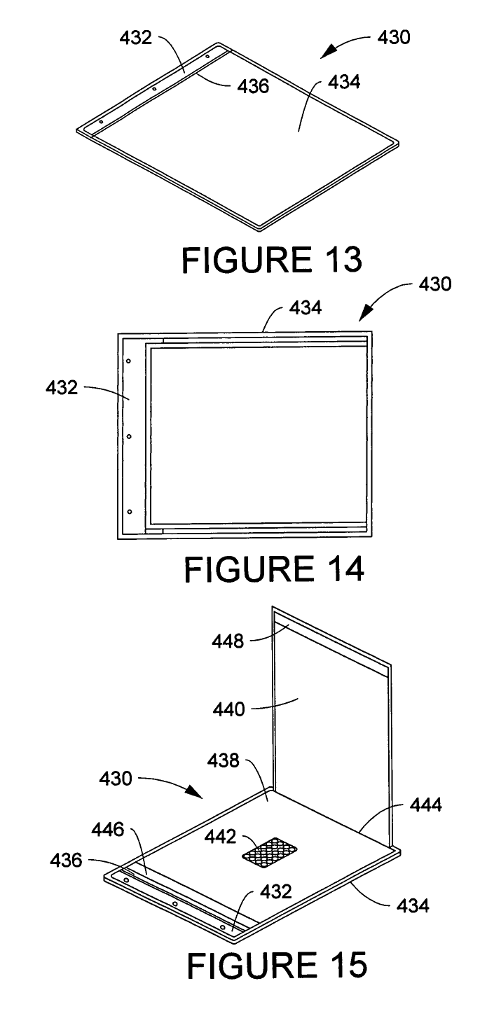

As illustrated in FIGS. 13 through 15, the cover 430 includes a foot portion 432 and a body portion 434 extending therefrom. The two portions 432, 434 are connected along a hinge line 436, which can be an integral portion of the material spanning both the foot portion 432 and the body portion 434. The foot portion 432 is secured to the countertop 418. The body portion 434 includes several pieces (see FIG. 15), including an upper panel 438, a lower panel 440, and a color checker 442. The lower panel 440 is hingedly connected to the upper panel 438 along a hinge line 444 to selectively expose the color checker 442. Velcro strips 446, 448 can be provided on the panels 438, 440, respectively, to secure the lower panel 440 in the closed position covering the color checker 442. The color checker 442 may be fixedly mounted on the underside of the upper panel 438, preferably in a central portion thereof. The color checker 442 can be positioned so that it is entirely visible through the window 420 when the lower panel 440 is pivoted to expose the color channel checker 442. The color checker 442 may be any conventional color checker known to those skilled in the art. The color checker 442 can be selected at least in part based on the colors anticipated to be measured by the system 410.

In operation, the color measurement system 410 is designed for installation within a kiosk or cabinet K to be located within a retail environment. The system 410 is designed to image artifacts provided by consumers for color matching to and selection of products within a database. The system 410 can be color calibrated using the color checker 442. The cover 430 can be raised to the position illustrated in FIG. 12, and the lower panel 440 pivoted away from the upper panel 438 (as illustrated in FIG. 15) to expose the color checker 442. The cover 430 is then lowered against the window 420 with the color checker 442 directly engaging the window 420. The system 410 is then actuated to image the color checker 442 and perform a color calibration in a fashion readily known to those skilled in the art. Following calibration, the cover 430 is raised and the lower panel 440 is returned to its normal position adjacent the upper panel 438 to hide the color checker 442. The Velcro strips 446, 448 retain the lower panel 440 in its normal position. Following color calibration, the system 410 is ready for use by a user (e.g., a customer or salesperson).

A sample or decorative artifact 405 to be imaged is provided by the customer or the retail associate. The artifact 405 may be a fabric, a floor covering, a wall covering, a tile, or virtually any other object or portion thereof. The cover 430 is raised to the position illustrated in FIG. 12, and the sample 405 is positioned over the window 420. If the sample 405 is relatively small, it may fit entirely within the frame 428. If the sample 405 is larger than the window 420, the sample 405 may extend beyond the frame 428 as illustrated in FIG. 12. In that case, the sample 405 can be positioned so that the area of interest is aligned with the window 420. The cover 430 is lowered to overly the sample 405 and the window 420 to block ambient light from entering the window 420. The color system 410 is then used to acquire a color image of the sample 405 to allow the product selection system (described above) to identify and extract color information.

The imaging system of the invention provides a system for accurately capturing precise color image information. The system is easy to use and promotes blockage of ambient light from entering the window 420. The illumination and imaging components are protected within an enclosure 412 that is not opened during normal use. The protection of the illumination and imaging components enhances the integrity and reliability of the system. The integral color checker 442 incorporated into the cover provides a readily accessible and protected device that can be used in color calibration.

For normal digital photography the goal is “appearance” rather than color, which allows illumination placement to be subjective. Generally, the photographer places lighting to create highlights and shadows as desired. To capture correct color across an entire image, using high resolution digital photography and allowing a variety of sample materials, can be more difficult. To achieve this with respect to embodiments of the invention, the sample can be distanced from the object and the lighting should not cast shadow or highlight.

The color of an object varies with the angle that the observer views the objects surface in relation to the illumination source. Typically, a person will describe color as seen off angle from the specular or mirror angle, ignoring the highlights and shadows. The angle subconsciously selected to describe an object's color is generally half way between the highlight and shadow or 45 degrees off specular. Placing a consistent and usable number on the color can be achieved in several ways.

There are many applications where the average color of a small region (e.g., about 25 millimeters or less) needs to be described. In these situations, there are four standard types of optical geometries: 0/45, 45/0, specular included sphere, and specular excluded sphere. For the purpose of spot measurement, these geometries work well. Embodiments of the invention may employ specular excluded sphere techniques, with several differences.

The specular excluded sphere standard is typically viewed off the sample perpendicular angle by 8 degrees. This allows manipulation of the sphere wall at the specular angle. In the invention, it can be perpendicular or 0 degrees off specular to retain a uniform image. Spot measurement viewing is collimated, allowing for a small resultant specular spot to be defined at the illumination wall. The viewing optic of the invention can be imaging, which causes a wide specular region back at the illumination wall. Since there is a need to reject specular light at the angle that includes the viewing optic, and the region is relatively large, methods are needed to avoid presenting this light. To achieve illumination uniformity, a black cone can be employed with the viewing optic placed low in a cylinder. This arrangement does not allow reflection of direct light emitted from the illumination wall to reflect off its surface. The cylinder can be made white or near white as needed to provide the correct color temperature.

Since the texture and gloss of the decorative artifact material can be variable, illumination is important. The camera can be placed perpendicular to the image for the sake of a variety of obvious imaging advantages, including focus, image distortion, and the least illumination limitation. To set the image camera distance precisely, an anti-reflective glass window can be used for sample placement. To eliminate highlights and shadows, light is directed uniformly upon the image region from all angles with the exception of those that are at the specular angle to the camera. The white cylinder's height is defined by the specular angle. The bottom surface of the cylinder is black, while the top is mostly white. Within the top white region is a neutral reflection gray for illumination calibration. One or more lamps can be pointed into the cylinder targeting the white cylinder walls. The combination of the lamp spectra and the spectra of the walls can be taken into account when determining the desired illumination, which may be about 5000 Kelvin (see CIE D50-2).

To control color consistently, a calibration sample can be placed to the side of the window, but still within the view range of the camera. This sample is used to set the white (or gray) balance for each image. Illumination varies in lightness from the center to the edges of the image area by a predictable amount. Since white balance is an “L” (or lightness) shift, this variation can be taken into account. Another color control process is to periodically read a set of colors to determine the proper color profile of the camera. This process brings consistency or inter-instrument agreement between cameras to a higher level. To make this step work, the colors can be placed close to the center of the image area where the illumination is most uniform and consistent with the position of samples to be profiled. This is accomplished by embedding the color set within the window cover for consistent presentation.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention.

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these sorts of focused discussions would not facilitate a better understanding of the present invention, and therefore, a more detailed description of such elements is not provided herein.

Any element expressed herein as a means for performing a specified function is intended to encompass any way of performing that function including, for example, a combination of elements that performs that function. Furthermore the invention, as may be defined by such means-plus-function claims, resides in the fact that the functionalities provided by the various recited means are combined and brought together in a manner as defined by the appended claims. Therefore, any means that can provide such functionalities may be considered equivalents to the means shown herein.

In general, it will be apparent to one of ordinary skill in the art that some of the embodiments as described hereinabove may be implemented in many different embodiments of software, firmware, and/or hardware. The software code or specialized control hardware used to implement some of the present embodiments is not limiting of the present invention. For example, the embodiments described hereinabove may be implemented in computer software using any suitable computer software language type such as, for example, C or C++ using, for example, conventional or object-oriented techniques. Such software may be stored on any type of suitable computer-readable medium or media such as, for example, a magnetic or optical storage medium. Thus, the operation and behavior of the embodiments are described without specific reference to the actual software code or specialized hardware components. The absence of such specific references is feasible because it is clearly understood that artisans of ordinary skill would be able to design software and control hardware to implement the embodiments of the present invention based on the description herein with only a reasonable effort and without undue experimentation.

Moreover, the processes associated with the present embodiments may be executed by programmable equipment, such as computers. Software that may cause programmable equipment to execute the processes may be stored in any storage device, such as, for example, a computer system (non-volatile) memory, an optical disk, magnetic tape, or magnetic disk. Furthermore, some of the processes may be programmed when the computer system is manufactured or via a computer-readable medium. Such a medium may include any of the forms listed above with respect to storage devices and may further include, for example, a carrier wave modulated, or otherwise manipulated, to convey instructions that may be read, demodulated/decoded and executed by a computer.

It can also be appreciated that certain process aspects described herein may be performed using instructions stored on a computer-readable medium or media that direct a computer system to perform process steps. A computer-readable medium may include, for example, memory devices such as diskettes, compact discs of both read-only and read/write varieties, optical disk drives, and hard disk drives. A computer-readable medium may also include memory storage that may be physical, virtual, permanent, temporary, semi-permanent and/or semi-temporary. A computer-readable medium may further involve one or more data signals transmitted on one or more carrier waves.

A “computer” or “computer system” may be, for example, a wireless or wire line variety of a microcomputer, minicomputer, server, mainframe, laptop, personal data assistant (PDA), wireless e-mail device (e.g., “BlackBerry” trade-designated devices), cellular phone, cable box, pager, processor, fax machine, scanner, or any other programmable device configured to transmit and receive data over a network. Computer devices disclosed herein may include memory for storing certain software applications used in obtaining, processing and communicating data. It can be appreciated that such memory may be internal or external to the disclosed embodiments. The memory may also include any means for storing software, including a hard disk, an optical disk, floppy disk, ROM (read only memory), RAM (random access memory), PROM (programmable ROM), EEPROM (electrically erasable PROM), and other computer-readable media.

In various embodiments of the invention disclosed herein, a single component may be replaced by multiple components, and multiple components may be replaced by a single component, to perform a given function or functions. Except where such substitution would not be operative to practice embodiments of the invention, such substitution is within the scope of the invention.

While various embodiments of the invention have been described herein, it should be apparent, however, that various modifications, alterations and adaptations to those embodiments may occur to persons skilled in the art with the attainment of some or all of the advantages of the present invention. The disclosed embodiments are therefore intended to include all such modifications, alterations and adaptations without departing from the scope and spirit of the present invention as set forth in the appended claims.

What is claimed is:

1. In a product selection system, a method for facilitating selection of a decorative product, the method comprising:
capturing an image of at least a portion of a decorative artifact with an imaging system, the captured image including associated color information;
using the color information associated with the captured image of the decorative artifact for searching a product database including color information for a plurality of decorative products; and,
identifying one or more decorative products in the product database having color information correlated with the color information associated with the captured image of the decorative artifact.

2. The method of claim 1, wherein the product database further comprises information about at least one physical location of at least one decorative product.

3. The method of claim 1, wherein the product database further comprises at least one of constituent color information or appearance information for at least one decorative product.

4. The method of claim 1, wherein the product selection system further comprises a consumer registry database including at least one color preference or decorative product preference of a consumer.

5. The method of claim 1, further comprising the product selection system being connected for communication in operative association with at least one supply chain system.

6. The method of claim 1, further comprising applying a quantizing algorithm to quantize colors within the color information associated with the captured image of the decorative artifact.

7. The method of claim 6, further comprising applying a collapsing algorithm to the quantized colors to generate a list of colors representative of the captured image.

8. The method of claim 7, further comprising generating at least one digital image representative of at least one of the quantized, collapsed colors.

9. The method of claim 8, wherein searching the product database further comprises comparing distance closeness in color space between the digital image of the at least one quantized, collapsed color and the color information in the product database.

10. The method of claim 9, further comprising returning at least one image from the product database based on the color distance comparison.

11. The method of claim 10, further comprising prioritizing the images returned from the product database.

12. The method of claim 1, further comprising permitting a consumer to identify at least one color to be used in searching the product database.

13. The method of claim 1, further comprising employing a web services server to control hardware locally installed with respect to the product selection system.

14. The method of claim 13, wherein the hardware comprises an image capture device of the imaging system.

15. The method of claim 1, further comprising handling at least one consumer interaction with the product selection system with a locally installed or server-based software.

16. The method of claim 1, wherein the decorative product is selected from the group consisting of furniture, clothing, flooring, wall coverings, window treatments, bedding, towels, doors, windows, and paint.

17. The method of claim 1, wherein the imaging system comprises:
(a) an enclosure having a sample window for receiving the decorative artifact portion thereon;
(b) at least one illumination source positioned within the enclosure;
(c) an imaging device for capturing the image of the decorative artifact portion; and,
(d) a movable cover mounted on the enclosure for selectively covering the sample window for promoting exclusion of ambient light during image capture.

18. The method of claim 17, wherein the cover further comprises a color checker selectively positionable on the sample window for calibration of the imaging system.

19. A product selection system for facilitating selection of a decorative product, the system comprising:
an imaging system for capturing an image of at least a portion of a decorative artifact, the captured image including associated color information;
at least one computer system operatively associated with the imaging system, the computer system being configured to use the color information associated with the captured image of the decorative artifact for searching a product database including color information for a plurality of decorative products; and,
the computer system being configured to identify one or more decorative products in the product database having color information correlated with the color information associated with the captured image of the decorative artifact.

20. The system of claim 19, wherein the product database further comprises information about at least one physical location of at least one decorative product.

21. The system of claim 19, wherein the product database further comprises at least one of constituent color information or appearance information for at least one decorative product.

22. The system of claim 19, wherein the product selection system further comprises a consumer registry database including at least one color preference or decorative product preference of a consumer.

23. The system of claim 19, further comprising the product selection system being connected for communication in operative association with at least one supply chain system.

24. The system of claim 19, further comprising the computer system being configured for applying a quantizing algorithm to quantize colors within the color information associated with the captured image of the decorative artifact.

25. The system of claim 24, further comprising the computer system being configured for applying a collapsing algorithm to the quantized colors to generate a list of colors representative of the captured image.

26. The system of claim 25, further comprising the computer system being configured for generating at least one digital image representative of at least one of the quantized, collapsed colors.

27. The system of claim 26, further comprising the computer system being configured for searching the product database by comparing distance closeness in color space between the digital image of the at least one quantized, collapsed color and the color information in the product database.

28. The system of claim 27, further comprising the computer system being configured for returning at least one image from the product database based on the color distance comparison.

29. The system of claim 28, further comprising the computer system being configured for prioritizing the images returned from the product database.

30. The system of claim 19, further comprising the computer system being configured to permit a consumer to identify at least one color to be used in searching the product database.

31. The system of claim 19, further comprising a web services server configured to control hardware locally installed with respect to the product selection system.

32. The system of claim 31, wherein the hardware comprises an image capture device of the imaging system.

33. The system of claim 19, further comprising a locally installed or server-based software for handling at least one consumer interaction with the product selection system.

34. The system of claim 19, wherein the decorative product is selected from the group consisting of furniture, clothing, flooring, wall coverings, window treatments, bedding, towels, doors, windows, and paint.

35. The system of claim 19, wherein the imaging system comprises:
(a) an enclosure having a sample window for receiving the decorative artifact portion thereon;
(b) at least one illumination source positioned within the enclosure;
(c) an imaging device for capturing the image of the decorative artifact portion; and,
(d) a movable cover mounted on the enclosure for selectively covering the sample window for promoting exclusion of ambient light during image capture.

36. The system of claim 35, wherein the cover further comprises a color checker selectively positionable on the sample window for calibration of the imaging system.
